(19) United States
(12) Patent Application Publication
(10) Pub. No.: US 2013/0321461 A1
(43) Pub. Date: Dec. 5, 2013

(54) Method and System for Navigation to Interior View Imagery from Street Level Imagery

(71) Applicant: Daniel Joseph Filip, San Jose, CA (US)

(72) Inventor: Daniel Joseph Filip, San Jose, CA (US)

(73) Assignee: GOOGLE INC., Mountain View, CA (US)

(21) Appl. No.: 13/482,390

(22) Filed: May 29, 2012

(51) Int. Cl. G09G 5/377

(52) U.S. Cl. 345/632

(57) ABSTRACT

Systems and methods for navigating and displaying imagery in a geographic information system for displaying interactive panoramic imagery are provided. According to aspects of the present disclosure, tools are provided for navigating from an exterior view to an interior view of a geographic object depicted in the interactive panoramic imagery. A preview image associated with the interior of the geographic object can be provided to the user to help the user decide whether to navigate to the interior of the geographic object. For instance, a preview image of the interior of the geographic object can be presented overlaying or within a selecting object in the viewport when the user positions the selecting object proximate a geographic location that has associated interior view imagery.

### FIELD

The present disclosure relates generally to displaying imagery, and more particularly to displaying and transitioning to interior view imagery associated with a geographic object.

### BACKGROUND

Computerized methods and systems for displaying imagery, in particular panoramic imagery are known. In the context of geographic information systems and digital mapping systems, services such as Google Maps are capable of providing street level images of geographical locations. The images, known on Google Maps as “Street View,” typically provide immersive 360° panoramic views centered around a geographic area of interest. The panoramic views allow a user to view a geographic location from a person's perspective, as if the user was located on the street level or ground level associated with the geographic location.

User interfaces for navigating immersive panoramic imagery, such as street level imagery, typically allow a user to pan, tilt, rotate, and zoom the panoramic imagery. In certain implementations, a user can select a portion of the imagery using a user manipulable selecting object, such as a cursor or a waffle, to jump to various different views in the panoramic imagery. For instance, a user can interact with or select a geographic object depicted in the distance from a particular view point in the panoramic imagery with the selecting object. The view of the panoramic imagery can then jump to a closer view of the geographic object to allow the geographic object to be examined by the user.

In certain cases, imagery associated with the interior of a geographic object depicted in the panoramic imagery can be available for navigation and/or inspection by the user. For instance, a user may be able to virtually enter the interior of a geographic object and view immersive panoramic imagery associated with the interior of the geographic object. Typically, however, users cannot readily ascertain the appearance of the interior of the geographic object from a viewpoint external to the geographic object to decide whether to virtually enter the geographic object. In addition, navigation between exterior and interior views of a geographic object can be cumbersome.

### SUMMARY

Aspects and advantages of the invention will be set forth in part in the following description, or may be obvious from the description, or may be learned through practice of the invention.

One exemplary aspect of the present disclosure is directed to a computer-implemented method for displaying imagery. The method includes presenting a viewport on a display of a computing device that displays at least a portion of interactive panoramic imagery of a geographic area. The interactive panoramic imagery depicts at least one geographic object in the geographic area, such as a building, monument, structure, arena, stadium, or other suitable geographic object. The method includes receiving a user input controlling a selecting object in the viewport. The user input positions the selecting object proximate the geographic object. The method further includes presenting a preview image associated with an interior view of the geographic object overlaying the selecting object in the viewport.

Other exemplary implementations of the present disclosure are directed to systems, apparatus, computer-readable media, devices, and user interfaces for presenting imagery associated with the interior of a geographic object.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary user interface for presenting interactive panoramic imagery according to an exemplary embodiment of the present disclosure;

FIG. 2 depicts exemplary interior view imagery according to an exemplary embodiment of the present disclosure;

FIG. 3 depicts an exemplary user interface presenting a preview image associated with an interior view of a geographic object according to an exemplary embodiment of the present disclosure;

FIG. 4 depicts an exemplary user interface presenting a preview image associated with an interior view of a geographic object according to an exemplary embodiment of the present disclosure;

FIG. 5 depicts an exemplary user interface presenting a preview image associated with an interior view of a geographic object according to an exemplary embodiment of the present disclosure;

FIG. 6 depicts an exemplary user interface presenting a preview image associated with an interior view of a geographic object according to an exemplary embodiment of the present disclosure;

FIGS. 7A and 7B depict an exemplary user interface presenting interactive panoramic imagery according to an exemplary embodiment of the present disclosure;

FIG. 8 depicts a computer based system for providing interactive panoramic imagery according to an exemplary embodiment of the present disclosure; and

FIG. 9 provides a flow diagram of an exemplary method for providing interactive panoramic imagery according to an exemplary embodiment of the present disclosure;

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for navigating and displaying imagery in a geographic information system configured to display interactive panoramic imagery associated with a geographic area, such as the Street View imagery provided by Google Inc. According to aspects of the present disclosure, tools are provided for navigating from an exterior view to an interior view of a geographic object depicted in the panoramic imagery, such as a building, arena, monument, or other suitable geographic object.

In particular, a user can provide a user input that controls a selecting object, such as a cursor or waffle, in a viewport displaying the interactive panoramic imagery. The user can position the selecting object such that the selecting object is located proximate a geographic object depicted in the imagery. If interior view imagery (i.e. imagery associated with the interior of the geographic object) is available for the geographic object, the user can provide a user interaction with the selecting object indicative of a request to view the interior imagery. The imagery can then transition or jump to the imagery associated with an interior view of the geographic object. For example, the user can click or tap with the selecting object at a location proximate the geographic object depicted in the imagery and the view of the geographic object will transition from an exterior view of the geographic object to an interior view of the geographic object. In this manner, a user can easily navigate to an interior view of a particular geographic feature using a simple gesture (e.g. a click, tap, finger swipe, or other gesture), leading to an improved navigation experience for the user. For instance, the user can actually feel as if the user is walking or otherwise going inside a particular geographic object from an external vantage point.

The interior view of the geographic object can be any suitable image associated with the interior of the geographic object, such as a photograph, a floor plan, a three dimensional model, or other suitable image associated with the interior of the geographic object. In a particular implementation, the interior view imagery is interactive panoramic imagery of the interior of the geographic object that allows a user to navigate and view the interior of the geographic object from a person's perspective within the interior of the geographic object.

In one implementation, a preview image associated with the interior of the geographic object can be provided to the user to help the user decide whether to navigate to the interior of the geographic object. For instance, a preview image of the interior of the geographic object can be presented in the viewport when the user locates the selecting object proximate a geographic object that has associated interior view imagery. The preview image can be any suitable image associated with the interior of the geographic object. In one aspect, the preview image can be presented overlaying or within the selecting object so that the preview image is readily noticeable by the user as the user navigates the imagery.

In a variation of this particular implementation, the user can navigate the preview image to view the interior view imagery from different perspectives. This can allow the user to perform a more in depth preview of the interior view imagery without having to actually navigate to the interior of the geographic object. Alternatively or in addition, the preview image can automatically navigate or adjust to different interior view images, for instance, to provide a tour of the interior view imagery. This enhanced preview imagery can further facilitate a user's decision to navigate to the interior of a geographic object. If a user decides not to navigate to the interior of the geographic feature, the viewpoint of the user can be returned or can remain at a perspective outside or from the exterior of the geographic object so that the user can continue the immersive navigation experience of the geographic area.

According to a particular aspect of the present disclosure, the preview image provided to the user is selected based on the position of the selecting object relative to the geographic object. For instance, the preview image provided to the user can be an image associated with the interior of the geographic object at the position of the selecting object. In particular, the preview image can be an image of the interior of the geographic object as viewed from an external vantage point with the exterior walls or surfaces of the geographic object removed. In one implementation, the user can pan the selecting object across the geographic object depicted in the imagery such that the selecting object appears to contour against a surface of the exterior of a geographic object. As the selecting object is panned across the geographic object, a plurality of different interior view images can be displayed as it pans across the surface of the geographic object corresponding to the position of the selecting object. In this manner, the preview image can act as a sliding window providing a view into the interior of the geographic object, providing the user a view of the interior of the geographic object based on the position of the selecting object.

Additional tools can be used to notify the user of the availability of the interior view imagery associated with a geographic object. In one implementation, an annotation, such as a text annotation (e.g. “Go Inside”), can be provided to the user when interior view imagery associated with a geographic object is available. The annotation can be configured to be displayed to the user when the user moves the selecting object proximate to a geographic object having associated interior view imagery. For instance, the annotation can appear within the selecting object when the selecting object hovers near or is proximate to a geographic object having interior view imagery. Alternatively, the annotation can be located on the exterior surface of the geographic object depicted in the panoramic imagery. The user can access interior view imagery by interacting with the annotation located on the exterior of the geographic object.

It is contemplated that the exemplary embodiments described herein can be used in various applications. For instance, a user can navigate from an exterior view of a hotel to an interior view of the lobby of the hotel. In addition or in the alternative, sample floor plans for various hotel rooms can be provided as an interior view image. Alternatively, the interior view can correspond with a commercial business and the interior view can be manipulated by a user to browse merchandise available at the commercial business. In yet another alternative embodiment, the geographic object can be a museum and the interior view imagery can correspond to gallery rooms where a user can navigate the interior view imagery to browse the artwork in the gallery.

In this manner, the present disclosure provides for more convenient and extensive navigation of imagery of a geographic object. The ability to conveniently navigate to interior view imagery of a geographic object from an exterior perspective can enhance the user's interactive experience. In addition, allowing a user to preview an interior view of the geographic object without navigating away from the exterior view of the geographic object can save user time and resources.

Referring now to the FIGS., exemplary embodiments of the present disclosure will now be discussed in detail. While the present disclosure is discussed with reference to interactive immersive panoramic imagery, such as street level imagery, those of ordinary skill in the art, using the disclosures provided herein, should understand that the present subject matter is equally applicable for use with any type of geographic imagery, such as the imagery provided in a virtual globe application, oblique view imagery, or other suitable imagery.

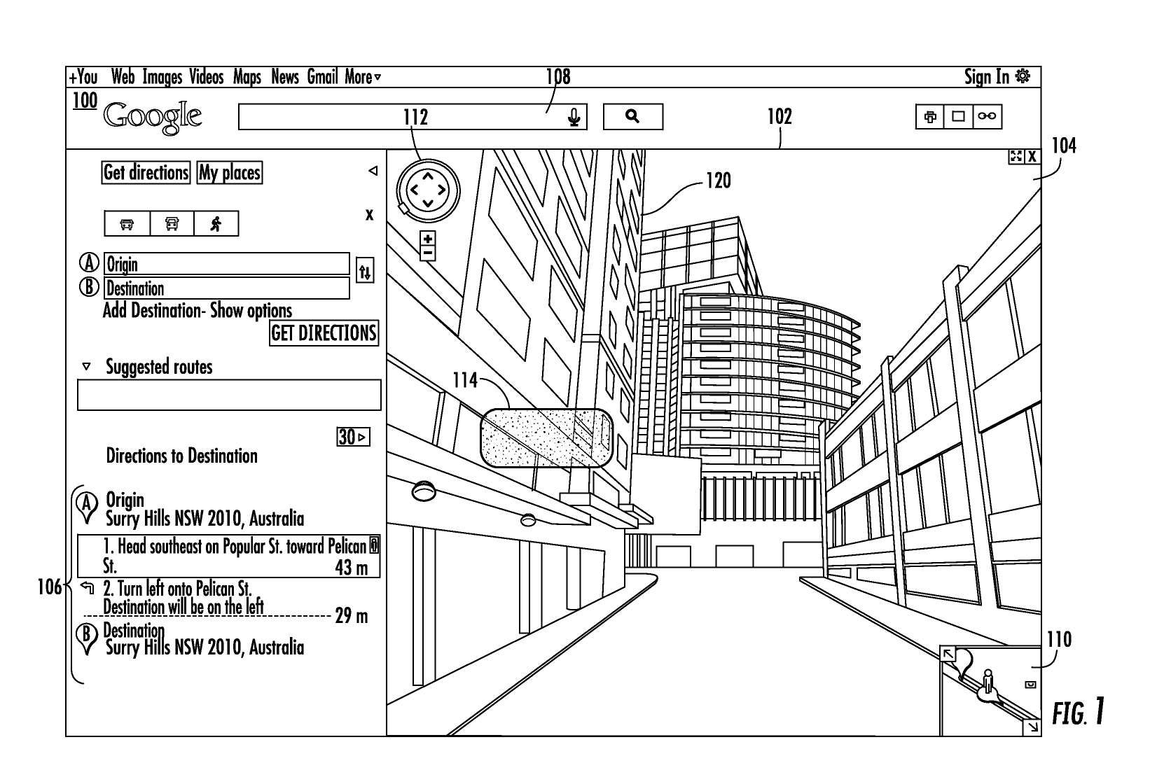

FIG. 1 depicts an exemplary user interface 100, such as a browser, that can be presented on a display of a computing device, such as a personal computer, smartphone, desktop, laptop, PDA, tablet, or other computing device. User interface 100 includes a viewport 102 that displays a portion of immersive 360° panoramic imagery, such as street level image 104. Street level image 104 depicts images of geographic objects captured by one or more cameras from a perspective at or near the ground level or street level. Although the present disclosure uses the term “street level” images, the immersive panoramas can depict non-street areas such as trails and building interiors. As discussed below, the street level image 104 is interactive such that the user can navigate the street level image 104 by panning, zooming, rotating, and tilting the view of the street level image 104. As shown, street level image 104 can provide an immersive viewing experience of a geographic area to a user.

In addition to street level image 104, user interface 100 can display a map and other information, such as travel directions 106 to a user. The user interface 100 can provide flexibility to the user in requesting street level imagery associated with a geographic area to be displayed through viewport 102. For instance, the user can enter text in a search field 108, such as an address, the name of a building, or a particular latitude and longitude. The user could also use an input device such as a mouse or touchscreen to select a particular geographic location shown on a map. Yet further, the user interface 100 can provide an icon or other feature that allows a user to request a street level view at a specified geographic location. When providing a street level image 104 in a viewport 102, the user interface 100 can indicate the location and orientation of the current view associated with the street level image 104 with a street level viewpoint signifier 110.

The user interface 100 can include user-selectable controls 112 for navigating the viewpoint associated with the imagery 104. The controls can include controls for zooming the image in and out, as well as controls to change the orientation of the view depicted in the imagery 104. The user can also adjust the viewpoint of the street level imagery 104 using a user manipulable selecting object 114, such as a cursor or waffle. For instance, a user can adjust the viewpoint by selecting and dragging the imagery to different views, for instance, with the selecting object 114 or through interaction with a touch screen. If the street level image 104 was downloaded as an entire 360° panorama, changing the direction of the view may necessitate only displaying a different portion of the panorama without retrieving more information from a server. Other navigation controls can be included as well, such as controls in the form of arrows disposed along a street that can be selected to move the vantage point up and down the street.

In one embodiment, a user can use the selecting object 114 to transition to various viewpoints within the immersive panoramic imagery. For instance, the user can position the selecting object 114 proximate a geographic object or other feature of interest. The selecting object 114 can be controlled using any suitable input device, such as a mouse, touchpad, touchscreen or other input device. As illustrated in FIG. 1, the selecting object 114 can appear to contour against the surface of the geographic objects depicted in the street level imagery 104 as the user moves the selecting object within the viewport 110. Upon receiving a user interaction indicative of a request to view a geographic object, the view of the street level image 104 can transition to a closer view of the geographic object of interest. In this manner, a user can use the selecting object 114 to click or tap to go to various geographic locations within the street level imagery 104.

According to aspects of the present disclosure, a user can use the selecting object 114 to jump or transition to interior view imagery associated with a geographic object depicted in the immersive panoramic imagery. For instance, as shown in FIG. 1, a user input can be received positioning the selecting object 114 proximate the geographic object 120. The exemplary geographic feature 120 depicted in FIG. 1 is a building, such as a hotel. However, those of ordinary skill in the art, using the disclosures provided herein, should understand that the geographic object can be any object having an interior depicted in the immersive panoramic imagery.

The user can provide a user interaction through the selecting object 114 indicative of a request to view imagery associated with the interior of the geographic object 120. For instance, the user can provide a double-click, double tap, finger swipe gesture, or other suitable user interaction with the selecting object 114 that indicates the user desires to view interior view imagery associated with the geographic object 120. In a particular embodiment, the user interaction indicative of a request to view interior view imagery can be different from user interactions indicative of requests to view exterior views of a geographic object.

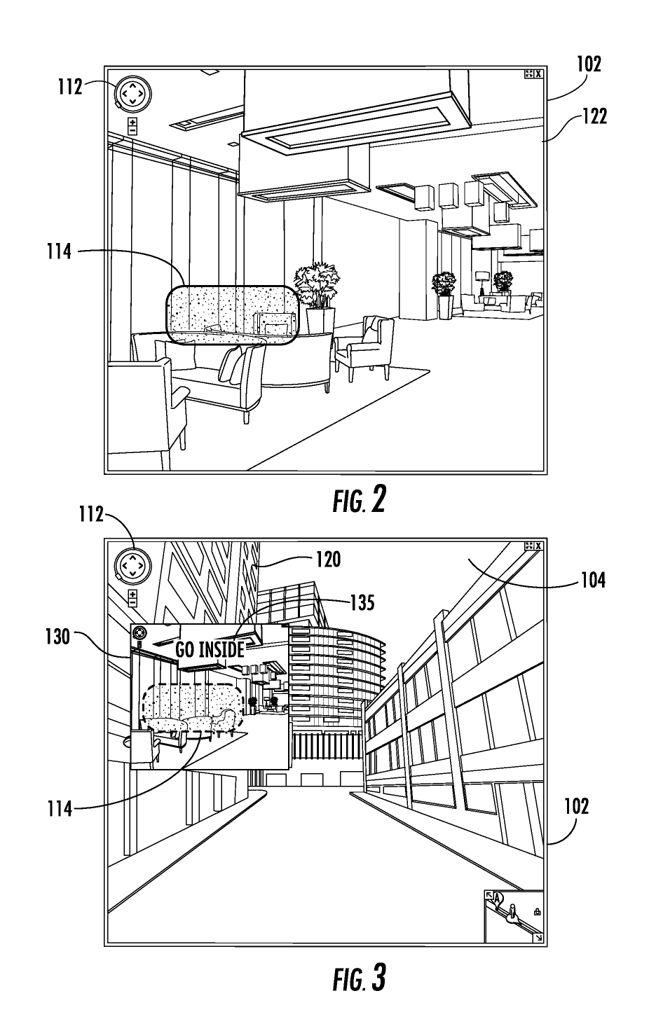

As shown in FIG. 2, once the user interaction indicative of the request to view interior view imagery is received, the imagery can transition to a display of interior view imagery 122 associated with the geographic object 120 in the viewport 102. The interior view imagery 122 can be any imagery associated with the interior of the geographic object. For instance, the interior view imagery can be a photograph of the interior of the geographic object. Alternatively, the interior view imagery can be a three dimensional model or other synthetic representation of the interior of the geographic object. Still further, the interior view imagery can include floor plans, table layouts, schematics, and other images associated with the interior of the geographic object.

In one example, the interior view imagery is interactive panoramic imagery, such as street level imagery. For instance, the interactive panoramic imagery can include a plurality of images of the interior of the geographic object captured by a camera used to make an interactive immersive panorama of the interior of the geographic object. A user can navigate the immersive panoramic imagery of the interior of the geographic object using, for instance, user selectable-controls 110 or user manipulable selecting object 114.

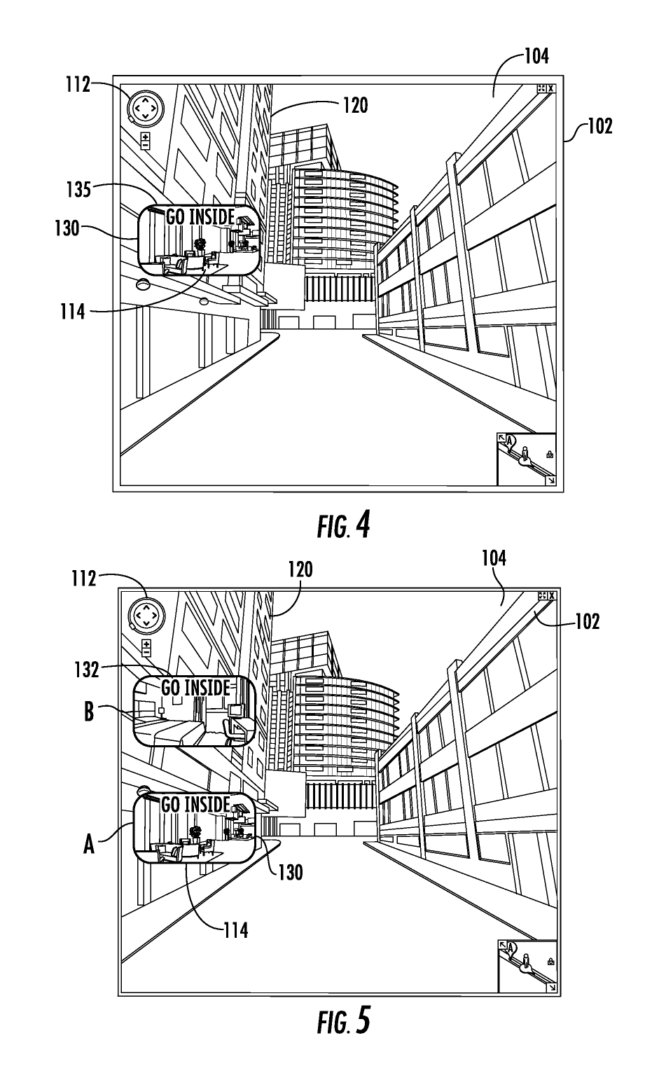

To assist a user in deciding whether to navigate to the interior of a geographic object, aspects of the present disclosure are directed to providing preview imagery associated with the interior of the geographic object to the user. For instance, as shown in FIG. 3, a preview image 130 associated with the interior of the geographic object 120 can be presented in the viewport 102. The preview image 130 can be any suitable image of the interior of the geographic object 120, such as a photograph, floor plan, three dimensional model, or other suitable image.

A preview image can be presented in the viewport whenever a user positions the selecting object proximate a geographic object having associated interior view imagery. For instance, the preview image 130 depicted in FIG. 3 is presented to the user when the user positions the selecting object 114 proximate the geographic object 120. Because the geographic object 120 has associated interior view imagery, the preview image 130 is provided to the user not only to provide a preview of the interior of the geographic object 120 to the user, but to also provide a notification of the ability to navigate to the interior of the geographic object 120.

In the exemplary embodiment depicted in FIG. 3, the preview image 130 is displayed overlaying the selecting object 114. More particularly, the preview image 130 is provided such that the preview image overlaps at least a portion of the selecting object 114 in the viewport. As a result, the preview image 130 is presented to the user at a location in the viewport 102 that at least partially already has the attention of the user. The preview image 130 is therefore more readily noticeable to the user and can more easily capture the attention of the user.

Additional annotations can be provided to notify the user of the ability to navigate to the interior of a geographic object. As shown in FIG. 3, a text annotation 135 is provided to the user notifying the user of the ability to “Go Inside” the geographic object 120. Other suitable annotations can be provided without deviating from the scope of the present disclosure. The text annotation 135 is provided overlapping the preview image 130 to be more readily noticeable by the user as the user is navigating the panoramic imagery. Once a user sees that the user has the ability to “Go Inside” the geographic object 120, the user can navigate to an interior view of the geographic object 140 by providing a suitable user interaction with the selecting object 114 or other user input mechanism.

The preview image can alternatively be displayed within the selecting object. In one aspect, the selecting object itself can become a preview image of the interior of a geographic object. For example, as shown in FIG. 4, the selecting object 114 provides a preview image 130 of the interior of geographic object 120 within the selecting object 114 as well as a suitable text annotation 135 notifying the user of the availability of the interior view imagery.

By presenting the preview image 130 within the selecting object 114, the selecting object 114 can act analogous to an x-ray of geographic objects depicted in the street level image 104. In particular, the selecting object 114 can provide x-ray vision or can act as a window to the interior of certain geographic objects depicted in the street level imagery 104. The user can get a feel for the interior of certain geographic objects depicted in the street level image 104 by panning the selecting object 114 along the surfaces of geographic objects depicted in the street level image 104.

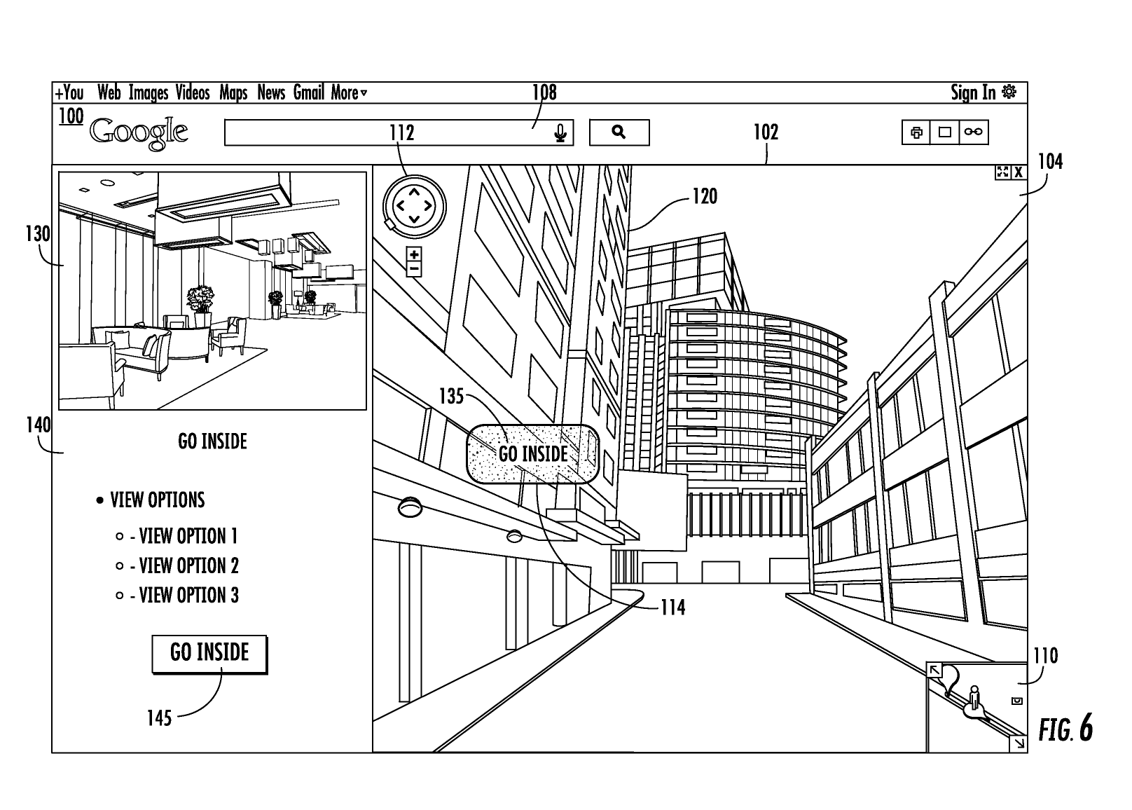

In one embodiment of the present disclosure, the preview image of the interior of a geographic object is selected based on the position of the selecting object relative to the geographic object in the viewport. For instance, as shown in FIG. 5, a first preview image 130 can be presented to the user when the selecting object 114 is located at position A and a second preview image 132 can be presented to the user when the selecting object is located at position B. As an example, when the selecting object 114 hovers over or is proximate to the first floor of geographic object 120, a preview image 130 of a hotel lobby can be provided to the user. When the selecting object 114 hovers over or is proximate to the upper floors of the geographic object 120, a preview image 132 of an exemplary hotel room can be provided to the user.

For certain geographic objects, the preview image of the interior geographic object can be different for every position of the selecting object relative to the geographic object. The preview image can be a view of the interior of the object from the perspective of external to the geographic object as if the outer walls or surface of the geographic object were removed. As the selecting object is panned across the geographic object, a plurality of different interior preview images can be displayed within the selecting object corresponding to the position of the selecting object. In this particular embodiment, the selecting object more closely resembles a sliding window into the interior of the geographic object.

Various techniques can be used for selecting a preview image based on the position of the selecting object 114 relative to the geographic object 120. In one particular implementation, the street view image 104 can include metadata associated with the street view image 104 that is indicative of the positions of geographic objects depicted in the street view image 104. For instance, the pixels associated with the street view image 104 can include pixel values having associated position data (e.g. latitude/longitude/altitude coordinates and/or distance to camera data). As the selecting object 114 hovers over a pixel or group of pixels the position data associated with the pixels can be used to select a preview image for display in the viewport 102.

For example, as shown in FIG. 5, when the selecting object 114 is proximate the pixels associated with position A, a computing device can identify the position of the selecting object 114 relative to the geographic object 120 based on the position data associated with the pixels overlapped by the selecting object 114 at position A. The computing device can then select preview image 130 for display based on the identified position. The preview image 130 can be displayed in the viewport 102 overlaying or within the selecting object 114 as shown in FIG. 5.

Similarly, when the selecting object 114 is proximate the pixels associated with position B, a computing device can identify the position of the selecting object 114 relative to the geographic object 120 based on the position data associated with the pixels overlapped by the selecting object 114 at position B. The computing device can then select preview image 132 for display based on the identified position. The preview image 132 can then be displayed in the viewport overlaying or within the selecting object 114 as shown in FIG. 5.

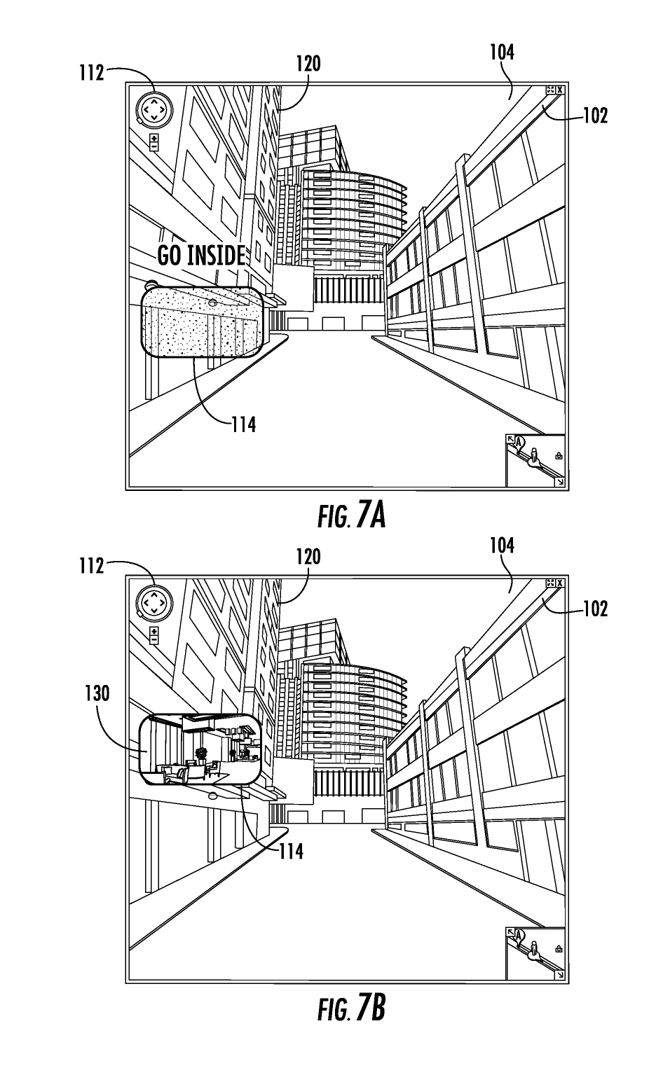

FIG. 6 depicts a user interface 100 including a preview image 130 according to another embodiment of the present disclosure. More particularly, when the user positions the selecting object 114 proximate a geographic object 120 having associated interior view imagery, an annotation 135 appears within the selecting object 114 to notify the user of the ability to navigate to interior view imagery. The annotation 135 can be any suitable indicia that can notify the user of the ability to navigate to interior view imagery. For instance, the annotation can be a text annotation (e.g. “Go Inside”). Alternatively, the annotation can include the selecting object changing shape, size, or color to provide notice of the ability to navigate to interior view imagery.

In addition to displaying the annotation 135 within the selecting object, a preview image 130 associated with the interior of the geographic object 120 can be presented in the user interface 100. Additionally, a plurality of interior view options 140 can be presented to the user. The plurality of interior view options 140 can include various different views or images of the interior of the geographic object 120. A user can select which interior view is of particular interest to the user and provide a user interaction with the user interface indicative of a request to navigate to the interior of the geographic object. For instance, the user can select a particular view option of the plurality of view options 140 and interact with icon 145 to indicate a request to navigate to the interior of the geographic object 120.

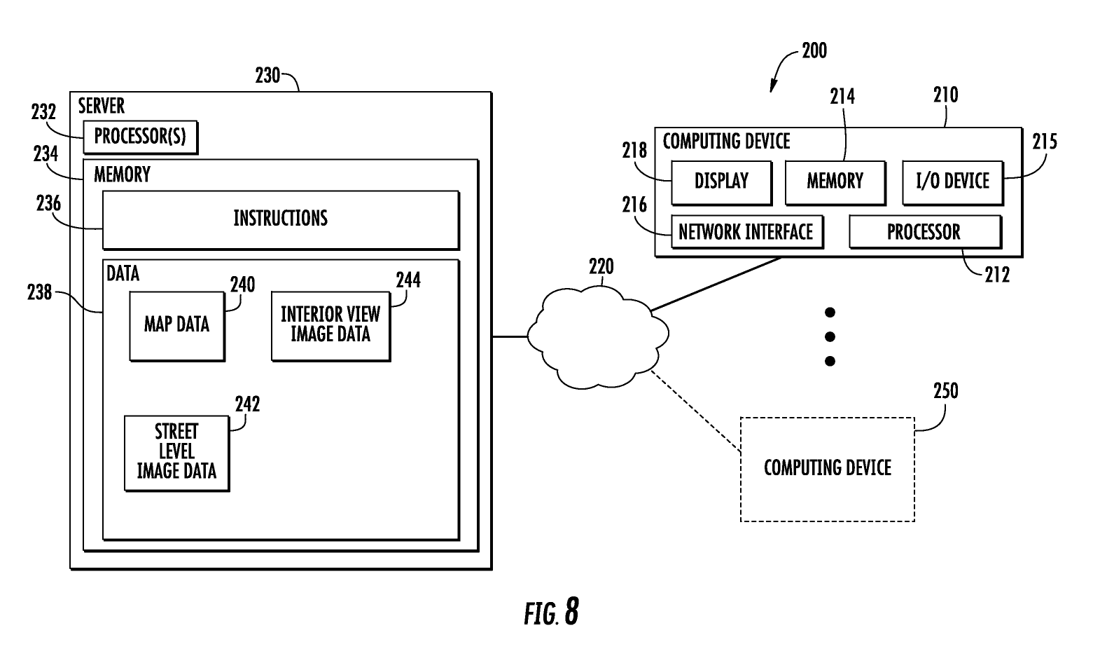

FIGS. 7A and 7B depict a user interface for navigating to the interior of a geographic object according to another exemplary embodiment of the present disclosure. As shown in FIG. 7A, the street level image 104 can include an annotation 135 rendered such that it appears on the exterior surface of the geographic object 120. The annotation 135 can be indicative of the availability of interior view imagery associated with the geographic object 120. For instance, the annotation 135 can be a text annotation (e.g. “Go Inside”) or other suitable indicia.

As shown in FIG. 7B, when the user positions the selecting object 114 proximate the annotation 135, a preview image 130 of the interior of the geographic object 120 is provided to the user. In FIG. 7B, the preview image 130 is provided within the selecting object 114. However, the preview image 130 can be provided at other suitable locations within the viewport 102. The user can navigate to the interior view imagery associated with the geographic object 120 by providing a user interaction or input indicative of a request to view the interior view imagery.

In another particular embodiment, the preview image 130, such as any of the preview images 130 depicted in FIGS. 3-7, can be interactive such that the user can navigate the preview image 130 before providing a user interaction indicative of a request to navigate to an interior view of the geographic object. For instance, the user can pan, tilt, zoom, or rotate the preview image 130 to get an enhanced preview of the interior view imagery associated with the interior of the geographic object. Alternatively, a user can simply scroll or toggle through additional interior view images associated with the interior of the geographic object. In another aspect, the preview image 130 can automatically navigate to or display new interior view imagery so as to provide a short tour of the interior of the geographic object. This enhanced preview imagery 130 can be provided to the user while the user is still viewing the geographic object from an external vantage point. If a user decides not to navigate to the interior of the geographic feature, the viewpoint of the user can be returned or can remain at a perspective outside or from the exterior of the geographic object so that the user can continue the immersive navigation experience of the geographic area.

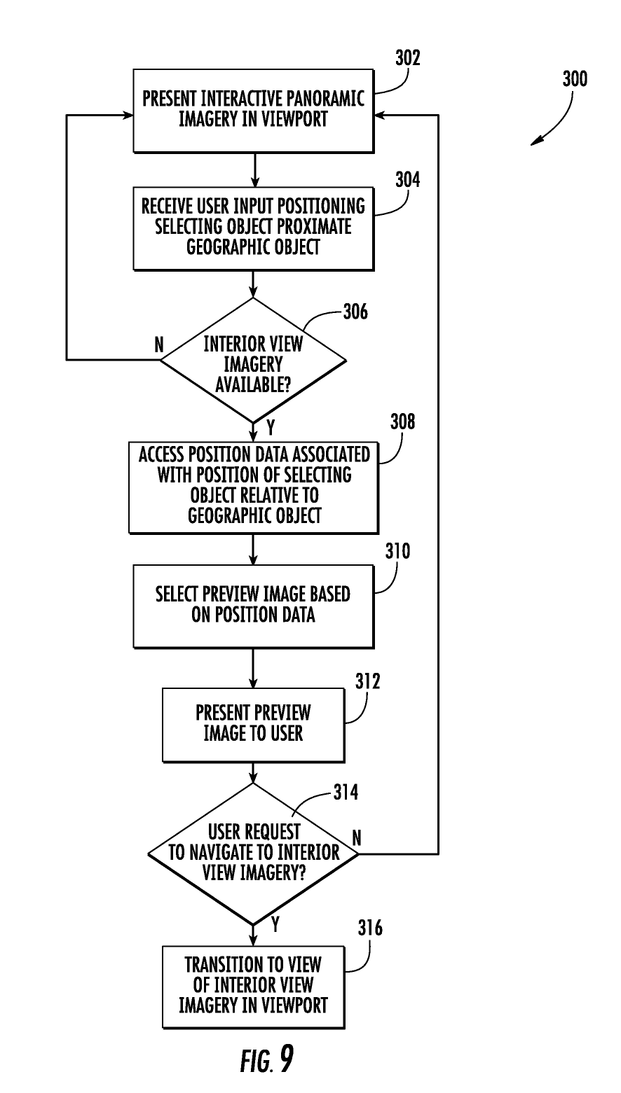

FIG. 8 depicts an exemplary computing system 200 that can be used to implement the techniques for displaying and navigating to interior view imagery associated with a geographic object according to exemplary embodiments of the present disclosure. System 100 includes a computing device 210 configured to display geographic imagery to a user. The computing device 210 can take any appropriate form, such as a personal computer, smartphone, desktop, laptop, PDA, tablet, or other computing device. The computing device 210 includes a display 218 for displaying the imagery to a user and appropriate input devices 215 for receiving input from the user. The input devices 215 can be any input device such as a touch screen, a touch pad, data entry keys, a mouse, speakers, a microphone suitable for voice recognition, and/or any other suitable device.

A user can request imagery by interacting with an appropriate user interface presented on the display 218 of computing device 210. The computing device 210 can then receive imagery and associated data and present at least a portion of the imagery through a viewport on any suitable output device, such as through a viewport set forth in a browser presented on the display 218.

The computing device 210 includes a processor(s) 212 and a memory 214. The processor(s) 212 can be any known processing device. Memory 214 can include any suitable computer-readable medium or media, including, but not limited to, RAM, ROM, hard drives, flash drives, or other memory devices. Memory 214 stores information accessible by processor(s) 212, including instructions that can be executed by processor(s) 212. The instructions can be any set of instructions that when executed by the processor(s) 112, cause the processor(s) 212 to provide desired functionality. For instance, the instructions when executed by the processor(s) 212 can cause the processor(s) 212 to present interactive panoramic imagery, such as street level imagery, according to any of the embodiments disclosed herein. The instructions can be software instructions rendered in a computer-readable form. When software is used, any suitable programming, scripting, or other type of language or combinations of languages can be used to implement the teachings contained herein. Alternatively, the instructions can be implemented by hard-wired logic or other circuitry, including, but not limited to application-specific circuits.

The computing device 210 can include a network interface 216 for accessing information over a network 220. The network 220 can include a combination of networks, such as cellular network, WiFi network, LAN, WAN, the Internet, and/or other suitable network and can include any number of wired or wireless communication links. For instance, computing device 210 can communicate through a cellular network using a WAP standard or other appropriate communication protocol. The cellular network could in turn communicate with the Internet, either directly or through another network.

Computing device 210 can communicate with another computing device 230 over network 220. Computing device 230 can be a server, such as a web server, that provides information to a plurality of client computing devices, such as computing devices 210 and 250 over network 220. Computing device 250 is illustrated in dashed line to indicate that any number of computing devices can communicate with computing device 230 over the network 220. Computing device 230 receives requests from computing device 210 and locates information to return to computing devices 210 responsive to the request. The computing device 230 can take any applicable form, and can, for instance, include a system that provides mapping services, such as the Google Maps services provided by Google Inc.

Computing device 230 can provide information, including street level imagery, interior view imagery, preview imagery, and associated information, to computing device 210 over network 220. The information can be provided to computing device 210 in any suitable format. The information can include information in HTML code, XML messages, WAP code, Flash, Java applets, xhtml, plain text, voiceXML, VoxML, VXML, or other suitable format. The computing device 210 can display the information to the user in any suitable format. In one embodiment, the information can be displayed within a browser, such as the Google Chrome browser or other suitable browser.

Similar to computing device 210, computing device 230 includes a processor(s) 232 and a memory 234. Memory 134 can include instructions 236 for receiving requests for geographic imagery from a remote client device, such as computing device 210, and for providing the requested information to the client device for presentation to the user. Memory 234 can also include or be coupled to various databases, such as database 238, that stores information that can be shared with other computing devices. Computing device 230 can communicate with other databases as needed. The databases can be connected to computing device 230 by a high bandwidth LAN or WAN, or could also be connected to computing device 230 through network 220. The databases, including database 238, can be split up so that they are located in multiple locales or they can be all in one location.

The database 238 can include a map information database 240, a street level image database 240, and an interior view image database 242. Database 238 can also include other data having information that can be accessed or used by computing device 230.

Map database 240 stores map-related information, at least a portion of which can be transmitted to a client device, such as computing device 210. For instance, map database 240 can store map tiles, where each tile is an image of a particular geographic area. Depending on the resolution (e.g. whether the map is zoomed in or out), a single tile can cover a large geographic area in relatively little detail or just a few streets in high detail. The map information is not limited to any particular format. For example, the images can include street maps, satellite images, oblique view images, or combinations of these.

The various map tiles are each associated with geographical locations, such that the computing device 230 is capable of selecting, retrieving and transmitting one or more tiles in response to receipt of a geographical location. The locations can be expressed in various ways including but not limited to latitude/longitude positions, street addresses, points on a map, building names, and other data capable of identifying geographic locations.

The map database 240 can also include points of interest. A point of interest can be any item that is interesting to one or more users and that is associated with a geographical location. For instance, a point of interest can include a landmark, stadium, park, monument, restaurant, business, building, or other suitable point of interest. A point of interest can be added to the map database 240 by professional map providers, individual users, or other entities.

The map database 240 can also store street information. In addition to street images in the tiles, the street information can include the location of a street relative to a geographic area or other streets. For instance, it can store information indicating whether a traveler can access one street directly from another street. Street information can further include street names where available, and potentially other information, such as distance between intersections and speed limits.

The street level image database 242 stores street level images associated with the geographic locations. Street level images comprise images of objects at geographic locations captured by cameras positioned at the geographic location from a perspective at or near the ground level or street level. Although the term “street level” images is used, the images can depict non-street areas such as trails and building interiors. The street level images can depict geographic objects such as buildings, trees, monuments, etc. from a perspective of a few feet above the ground. The street level images can be used to provide an immersive 360° panoramic viewing experience to a user centered around a geographic area of interest.

The images can be captured using any suitable technique. For instance, the street level images can be captured by a camera mounted on top of a vehicle, from a camera angle pointing roughly parallel to the ground and from a camera position at or below the legal limit for vehicle heights (e.g. 7-14 feet). Street level images are not limited to any particular height above the ground. For example, a street level image can be taken from the top of a building. Panoramic street level images can be created by stitching together the plurality of photographs taken from the different angles. The panoramic image can be presented as a flat surface or as a texture-mapped three dimensional surface such as, for instance, a cylinder or a sphere.

The street level images can be stored in the street level database 242 as a set of pixels associated with color and brightness values. For instance, if the images are stored in JPEG format, the image can be displayed as a set of pixels in rows and columns, with each pixel being associated with a value that defines the color and brightness of the image at the pixel's location.

The street level image database 242 can include position information associated with the geographic objects depicted. For instance, the position information can include information concerning the location and/or position of objects in the three-dimensional space defined by the street level imagery, latitude, longitude, and/or altitude of the geographic object, the orientation of the image with respect to user manipulation, and/or other spatial information.

As an example, a separate value(s) can be stored in the street level image database 140 for each pixel of the street level image, where the value represents the geographic position of the surface of the object illustrated in that particular pixel. For instance, a value representing latitude, longitude, and altitude information associated with the particular surface illustrated in the pixel can be associated with the pixel. In yet another aspect, the street level image database 242 can include distance data that represents the distances of the surfaces of the object depicted in the street level imagery relative to the street level perspective. For instance, a value representing the distance from the perspective the image was acquired to a surface of the geographic object depicted in the street level image can be associated with each pixel.

In another aspect, the street level image database 242 can include information associated with the locations of the surfaces depicted in street level or interior-view images as polygons. In particular, a surface of an object depicted in the street view image can be defined as a polygon with four vertices. Each vertex can be associated with a different geographic object. A surface can be referenced in the street level image database 242 as a set of vertices at the various geographic positions associated with the object.

Other formats for storing surface information of the street level images can also be used. For instance, rather than being associated with absolute position values, such as latitude, longitude, and altitude, the values can be relative and in any scale. The locations of the surfaces depicted in the street level images can be saved as polygons. Moreover, even if a first type of information is used (such as storing latitude, longitude, and altitude information for the surface) information of another type can be generated from the first type of information (such as differences between positions to calculate distances).

A variety of systems and methods can be used to collect the position information to be stored in the street level database 242. For instance, a laser range finder can be used. Alternatively, a three-dimensional model can be generated from a plurality of street view images using a variety of known techniques. For instance, stereoscopic techniques can be used to analyze a plurality of street level images associated with the same scene to determine distances at each point in the images. Once the relative locations of the points in the images are known, a three-dimensional model associated with the geographic area can be generated. The three-dimensional model can include information such as the location of surfaces of objects depicted in the street level imagery. Computing device 230 can access the three-dimensional model to provide position information to one or more client devices, such as computing device 210.

The database 238 can also include interior view imagery database 244. The interior view imagery database 244 can store imagery associated with an interior view of a geographic object. The interior view images can be any type of image related to an interior view of the geographic object. For instance, the interior view images can include photographs, floor plans, three dimensional models, or other suitable images associated with the interior of the geographic object.

In a particular implementation, the interior view imagery includes interactive panoramic imagery of the interior of the geographic object that allows a user to navigate and view of the interior of the geographic object from a person's perspective within the interior of the geographic object. Similar to the street level images stored in the street level data based 242, the interior view images can depict the interior of geographic objects from a perspective of a few feet above the ground. The interior view images can be used to provide an immersive 360° panoramic viewing experience to a user centered around a geographic area of interest. The interior views images can be captured using any suitable technique, such as by a camera mounted a few feet above the floor of the interior of the geographic object. Panoramic interior view images can be created by stitching together a plurality of photographs taken from various angles. The panoramic image can be presented as a flat surface or as a texture-mapped three dimensional surface such as, for instance, a cylinder or a sphere.

The interior view image database 244 can also store a plurality of preview images associated with the interior of a geographic object. The preview images can be any suitable image of the interior of a geographic object and can be stored in any suitable format. The preview image can be provided to a user as the user views street level imagery associated with the exterior of a geographic object to assist the user in deciding whether to navigate to the interior of the geographic object.

The interior view image database 244 can further include information relating to the position of the interior view images and preview images, such the location and/or position of the interior view image and preview images with respect to the exterior of a geographic object. This position information can be used in conjunction with position information stored in the street level database 242 to select particular preview images for display to a user as the user navigates or views the exterior of a geographic object.

FIG. 9 depicts a flow diagram of an exemplary computer-implemented method 300 according to an exemplary embodiment of the present disclosure. The exemplary method 300 can be implemented using any computing device or system, such as the computing device 110 of FIG. 1. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods can be omitted, rearranged, combined and/or adapted in various ways.

At (302), the method can include presenting interactive panoramic imagery in a viewport. For instance, the computing device can present street level imagery depicting at least one geographic object in a geographic area in the viewport of a user interface presented on a display of the computing device. At (304), the method includes receiving a user input positioning a selecting object, such as a cursor or waffle, proximate the geographic object depicted in the interactive panoramic imagery.

At (306), the method determines whether interior view imagery is available for the geographic object. If not, the method continues to present the interactive panoramic imagery as shown at (302). If interior view imagery is available, the method can include accessing position data associated with the position of the selecting object relative to the geographic object (308). For instance, the method can identify pixels proximate to the selecting object and extract position data associated with the identified pixels.

At (310), the method includes selecting a preview image for display in the viewport based on the position data. For instance, if the selecting object is proximate a first position relative to the geographic object, the method can include selecting a first preview image associated with the interior of the geographic object. If the selecting object is proximate a second position relative to the geographic object, the method can include selecting a second preview imager associated with the interior of the geographic object.

At (312), the preview image is presented to the user. In one embodiment, the preview image is presented overlaying or within the selecting object. As a result, the preview image can be presented to a user in the viewport at a position that at least partially already has the attention of the user. The preview image not only provides a preview of the interior imagery associated with the geographic object but also provides a notification of the availability of interior view imagery associated with the geographic object. The method can further include displaying other annotations, such as text annotations or other indicia, that notify the user of the availability of interior view imagery. For instance, the method can display a text annotation (e.g. “Go Inside”) to indicate the availability of interior view imagery associated with the geographic object.

At (314), the method determines whether a user interaction indicative of a request to navigate to interior view imagery is received. For instance, the method determines whether the user has provided a user input indicative of a request to navigate to the interior view imagery. If not, the method continues to display the interactive panoramic imagery in the viewport as shown at (302). If the user does provide a user input indicative of a request to navigate to interior view imager, the method transitions to a view of interior view imagery in the viewport (316). In this manner, a user can easily navigate to an interior view of a particular geographic feature from an exterior vantage point, leading to an improved navigation experience for the user.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for displaying imagery associated with an interior of a geographic object, the method comprising:
presenting a viewport on a display of a computing device that displays at least a portion of interactive panoramic imagery of a geographic area, the interactive panoramic imagery depicting a geographic object in the geographic area;
receiving a user input controlling a selecting object in the viewport, the user input positioning the selecting object proximate the geographic object; and
presenting a preview image associated with an interior view of the geographic object overlaying the selecting object in the viewport.

2. The computer-implemented method of claim 1, wherein the preview image is presented within the selecting object in the viewport.

3. The computer-implemented method of claim 1, wherein the method comprises:
receiving a user interaction with the selecting object indicative of a request to view interior view imagery associated with the geographic object; and
transitioning to a display of interior view imagery of the geographic object in the viewport.

4. The computer-implemented method of claim 3, wherein the interior view imagery comprises interactive panoramic imagery of the interior of the geographic object.

5. The computer-implemented method of claim 1, wherein upon receiving the user interaction indicative of a request to view interior view imagery, the method comprises:
presenting a plurality of interior view options;
receiving a user input selecting one of the plurality of interior view options; and
transitioning to a view of the interior view imagery based on the selected interior view option.

6. The computer-implemented method of claim 1, wherein the method comprises displaying an annotation indicative of the ability to navigate to interior view imagery when the selecting object is positioned proximate a geographic object having associated interior view imagery.

7. The computer-implemented method of claim 6, wherein the annotation is displayed within the selecting object.

8. The computer-implemented method of claim 6, wherein the annotation comprises a text annotation.

9. The computer-implemented method of claim 1, wherein the method comprises displaying at least one annotation in the viewport overlaying the geographic object, the annotation indicative of the ability to navigate to interior view imagery associated with the geographic object.

10. The computer-implemented method of claim 9, wherein the preview image associated with an interior view of the geographic object is presented when the selecting object is positioned proximate the annotation.

11. The computer-implemented method of claim 1, wherein presenting the preview image associated with the interior view of the geographic image overlaying the selecting object in the viewport comprises:
identifying a position of the selecting object relative to the geographic object;
selecting a preview image based on the position of the selecting object relative to the geographic object; and
presenting the selected preview image overlaying the selecting object in the viewport.

12. The computer implemented method of claim 1, wherein the preview image is interactive.

13. The computer-implemented method of claim 1, wherein the method further comprises automatically adjusting the preview image to display additional interior view imagery.

14. A computing device for displaying imagery associated with an interior of a geographic object, the computing device comprising:
a display device;
one or more processors; and
at least one memory, the at least one memory comprising computer-readable instructions for execution by the one or more processors to cause the processors to perform operations, the operations comprising:
presenting a viewport on the display device that displays at least a portion of interactive panoramic imagery of a geographic area, the interactive panoramic imagery depicting a geographic object in the geographic area;
receiving a user input controlling a selecting object in the viewport, the user input positioning the selecting object proximate the geographic object;
presenting a preview image associated with an interior view of the geographic object within the selecting object in the viewport;
receiving a user interaction with the selecting object indicative of a request to view interior view imagery associated with the geographic object; and
transitioning to a display of interior view imagery of the geographic object in the viewport.

15. The computing device of claim 14, wherein the interior view imagery comprises interactive panoramic imagery of the interior of the geographic object.

16. The computing device of claim 14, wherein upon receiving the user interaction indicative of the request to view interior view imagery, the operations further comprise:
presenting a plurality of interior view options;
receiving a user input selecting one of the plurality of interior view options; and
transitioning to a view of the interior view imagery based on the selected interior view option.

17. The computing device of claim 14, wherein the operations comprise displaying an annotation within the selecting object indicative of the ability to navigate to interior view imagery when the selecting object is positioned proximate a geographic object having associated interior view imagery.

18. The computing device of claim 14, wherein the operation of presenting a preview image associated with the interior view of the geographic image within the selecting object in the viewport comprises:
identifying a position of the selecting object relative to the geographic object;
selecting a preview image based on the position of the selecting object relative to the geographic object; and
presenting the selected preview image within the selecting object in the viewport.

19. A computer-implemented method of displaying imagery associated with an interior of a geographic object, comprising:
presenting a viewport on a display of a computing device that displays at least a portion of interactive panoramic imagery of a geographic area, the interactive panoramic imagery depicting a geographic object in the geographic area;
receiving a user input controlling a selecting object in the viewport, the user input positioning the selecting object proximate the geographic object;
presenting a preview image in the viewport associated with an interior view of the geographic object in the viewport;
receiving a user interaction with the selecting object requesting to view interior view imagery associated with the geographic object; and
transitioning to a display of interior view imagery of the geographic object in the viewport.

20. The computer-implemented method of claim 19, wherein the interior view imagery comprises interactive panoramic imagery of the interior of the geographic object.
